(19) United States
(12) Patent Application Publication
(10) Pub. No.: US 2023/0412472 A1
(43) Pub. Date: Dec. 21, 2023

(54) 3D-O-RAN: Dynamic Data Driven Open Radio Access Network Systems

(71) Applicant: Northestern University, Boston, MA (US)

(72) Inventors: Francesco Restuccia, Boston, MA (US); Erik Blasch, Arlington, VA (US); Jonathan Ashdown, Arlington, VA (US); Kurt Turck, Arlington, VA (US)

(73) Assignee: Northestern University, Rome, NY (US)

(21) Appl. No.: 18/338,614

(22) Filed: Jun. 21, 2023

Related U.S. Application Data
(60) Provisional application No. 63/366,752, filed on Jun. 21, 2022.

(51) Int. Cl. H04L 41/16; H04L 41/5003; G06N 3/04

(52) U.S. Cl. CPC H04L 41/16; H04L 41/5003; G06N 3/04

(57) ABSTRACT

A method of generating a deep neural network (DNN) may comprise receiving one or more application-level requirements associated with network communications, translating the one or more application-level requirements into one or more technical constraints, and providing the one or more technical constraints to a control loop that generates a certified DNN architecture based on the technical constraints. The control loop may further comprise a DNN search engine and a hardware synthesis engine. The method may comprise selecting, using the DNN search engine, a candidate DNN architecture based on the technical constraints, and generating, using the hardware synthesis engine, a hardware architecture corresponding to the selected candidate DNN architecture. The technical constraints may comprise one or more of (i) network latency, (ii) available hardware resources, (iii) available software resources, (iv) required DNN accuracy, (iv) computation and/or network slicing allocation, and (v) current noise and/or interference levels at the DNN input.

### RELATED APPLICATION

This application claims the benefit of U.S. Provisional Application No. 63/366,752, filed on Jun. 21, 2022. The entire teachings of the above application(s) are incorporated herein by reference.

### GOVERNMENT LICENSE RIGHTS

This invention was made with government support under Grant No. 1925601, 2134973, and 2201536 awarded by the National Science Foundation, and FA8750-20-3-1003 awarded by the AFRL. The government has certain rights in the invention.

### BACKGROUND

Current wireless topologies (e.g., 5G/6G) are faced with a challenging spectrum environment due to various contributing causes that may include, for example, unmitigated adversarial spectrum usage and extensive commercial use. Ensuring spectrum flexibility within this formidable spectrum environment requires radically novel wireless networking paradigms.

### SUMMARY

The example embodiments described herein are directed to a concept in wireless networking, referred to herein as Dynamic Data Driven Open Radio Access Network System (3D-O-RAN). 3D-O-RAN is a dynamic data driven application system where the computational, sensing, and networking components are tightly integrated in a highly-dynamic, feedback-based control loop.

Specifically, 3D-O-RAN is designed to incorporate heterogeneous sensor data (e.g., spectrum, multimedia) into the control loop to dynamically achieve a system-wide optimal operating point, and dynamically steer the multimedia sensor measurement process according to the required application needs and current physical and/or environmental constraints. Based on actual system status at a particular point in time, the described system establishes specific constraints on network latency, power, and available software resources. Such adaptivity is required because those assets tend to change with respect to time. In the described embodiments, application-level objectives, such as end-to-end latency and accuracy, are translated into dynamic technical constraints on network latency, hardware/software (HW/SW) resources, and DNN-level accuracy.

In one aspect, the invention may be a method of generating a deep neural network (DNN), comprising receiving one or more application-level requirements associated with network communications, translating the one or more application-level requirements into one or more technical constraints, and providing the one or more technical constraints to a control loop that generates a certified DNN architecture based on the provided technical constraints.

The mission-critical requirements may comprise end-to-end network latency and DNN accuracy. The control loop may comprise a DNN search engine and a hardware synthesis engine. The method may further comprise (i) selecting, using the DNN search engine, a candidate DNN architecture based on the technical constraints, and (ii) generating, using the hardware synthesis engine, a hardware architecture corresponding to the selected candidate DNN architecture.

The hardware architecture may comprise a DNN structure and associated weighting coefficients. The method may further comprise determining, using the hardware synthesis engine, latency and energy consumption associated with the generated DNN hardware architecture, and providing the generated latency and energy consumption associated the DNN hardware architecture to the DNN search engine. The method may further comprise revising, by the DNN search engine using the latency and energy consumption associated with the DNN hardware architecture, the selected DNN architecture to produce the certified DNN architecture.

The technical constraints may comprise one or more of (i) network latency, (ii) available hardware resources, (iii) available software resources, (iv) required DNN accuracy, (iv) computation and/or network slicing allocation, (v) current noise and/or interference levels at an input of the DNN. The method may further comprise producing, by the certified DNN architecture, a certified DNN output based on the certified DNN architecture and a dynamic DNN input. The control loop may revise the certified DNN architecture based on the certified output.

In another aspect, the invention may be a system for of generating a deep neural network (DNN), comprising a translation module that receives one or more application-level requirements associated with network communications, and translates the one or more application-level requirements into one or more technical constraints. The system may further comprise a control loop module that uses the one or more technical constraints to generate a DNN architecture based on the provided technical constraints.

In another aspect, the invention may be a method of generating a certified deep neural network (DNN) architecture, comprising providing one or more technical constraints to a control loop that comprises a DNN search engine and a hardware synthesis engine, and generating, using the control loop, a certified DNN architecture based on the provided technical constraints.

The method may further comprise (i) selecting, using the DNN search engine, a candidate DNN architecture based on the technical constraints, and (ii) generating, using the hardware synthesis engine, a hardware architecture corresponding to the selected candidate DNN architecture, the hardware architecture comprises a DNN structure and associated weighting coefficients. The method may further comprise determining, using the hardware synthesis engine, latency and energy consumption associated with the generated DNN hardware architecture, and providing the generated latency and energy consumption associated the DNN hardware architecture to the DNN search engine.

The method may further comprise determining, using the hardware synthesis engine, latency and energy consumption associated with the generated DNN hardware architecture, and providing the generated latency and energy consumption associated the DNN hardware architecture to the DNN search engine. The method may further comprise revising, by the DNN search engine using the latency and energy consumption associated with the DNN hardware architecture, the selected DNN architecture to produce the certified DNN architecture.

The technical constraints comprise one or more of (i) network latency, (ii) available hardware resources, (iii) available software resources, (iv) required DNN accuracy, (iv) computation and/or network slicing allocation, (v) current noise and/or interference levels at an input of the DNN. The method may further comprise producing, by the certified DNN architecture, a certified DNN output based on the certified DNN architecture and a dynamic DNN input. The control loop may revise the certified DNN architecture based on the certified output. The method may further comprise receiving one or more application-level requirements associated with network communications, and translating the one or more application-level requirements into the one or more technical constraints.

In another aspect, the invention may be a system for generating a certified deep neural network (DNN) architecture, comprising a control loop module that uses the one or more technical constraints to generate a DNN architecture based on the provided technical constraints. The control loop module may comprise a DNN search engine and a hardware synthesis engine. The system may further comprise a translation module that receives one or more application-level requirements associated with network communications, and translates the one or more application-level requirements into the one or more technical constraints.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 shows a high-level overview of Dynamic Data Driven Open Radio Access Network System (3D-O-RAN).

FIG. 2 shows the block diagram of an example embodiment of a Dynamic Data Driven DNN Certification System (4D-CS).

### DETAILED DESCRIPTION

A description of example embodiments follows.

Ensuring spectrum flexibility within a daunting wireless spectrum environment requires radically novel wireless networking paradigms, where intelligence, adaptability, flexibility and security are deeply embedded in the wireless communications systems. To this end, the Open Radio Access Network (O-RAN) paradigm can bring together open interfaces, softwarization of network components and multi-vendor interoperability. Specifically, O-RAN may provide a platform where tactical services can be dynamically deployed on-demand in a matter of seconds via plug-and-play software containers. The O-RAN capability empowers a concrete solution to enable dynamic data driven network control, to promptly respond to emergencies, threats and mission requirements. Moreover, O-RAN is, by definition, platform-independent, so (i) data-driven control algorithms can be deployed in vendor-agnostic O-RANs, ultimately reducing costs to develop and operate the network, and (ii) network intelligence can be used to operate secure network slices with diverse latency, throughput and reliability requirements and regulate coexistence with other networks.

To achieve reliable operations through O-RAN architectures, constituent systems will need real-time spectrum and situational awareness through the gathering and processing of heterogeneous sensor data. To this end, future products are expected to extensively rely on artificial intelligence (AI) to automate strategic decision-making in a cost-effective manner. However, as AI becomes such a critical system component, it is imperative to guarantee certifiability of AI techniques through explainability of the outputs, interpretability of the processing, and accountability of the decision-making process.

Specifically, the AI capabilities are expected to have explicit, well-defined uses. The safety, security, and effectiveness of such capabilities should be subject to testing and assurance within those defined uses across their entire life-cycles. To attest to the criticality of Certifiable AI, on Mar. 5, 2021, the National Security Commission on Artificial Intelligence (NSCAI) has mentioned in its final report [E. Schmidt, B. Work, S. Catz, S. Chien, C. Darby, K. Ford, J.-M. Griffiths, E. Horvitz, A. Jassy, W. Mark et al., “Final Report, National Security Commission on Artificial Intelligence (AI),” https://apps.dtic.mil/sti/citations/AD1124333, 2021] the need to “[ . . . ] include an evaluation of technical standards and production and transmission pipelines,” while on Nov. 15, 2021, the Defense Innovation Unit (DIU), in its initial “Responsible AI Guidelines” document, indicated the need to “[ . . . ] create a task force to study the use of AI and complementary technologies, including the development and deployment of standards and technologies, for certifying content authenticity and provenance” [Department of Defense, “Defense Innovation Unit Publishes ‘Responsible AI Guidelines’,” https://www.defense.gov/News/News-Stories/Article/Article/2847598/defense-innovation-unit-publishes-responsible-ai-guidelines/, November 2021].

### Dynamic Data Driven Open RAN System

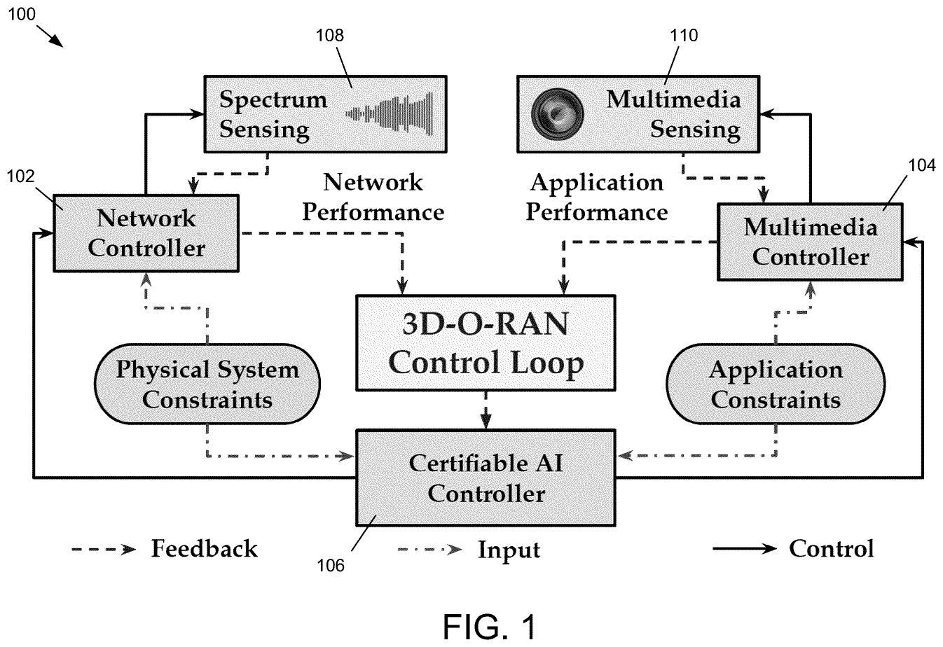

Addressing the above-described issues requires a fundamentally novel approach at the intersection of networking, computing, and optimization. As such, the example embodiments described herein present a new concept in wireless networking, referred to herein as Dynamic Data Driven Open Radio Access Network System (3D-O-RAN). FIG. 1 shows a high-level overview of 3D-O-RAN. At its core, 3D-O-RAN is a dynamic data driven application system (DDDAS) where the computational, sensing, and networking components are tightly integrated in a highly-dynamic, feedback-based control loop. Specifically, 3D-O-RAN is designed to incorporate heterogeneous sensor data (e.g., spectrum, multimedia) into the control loop to dynamically achieve a system-wide optimal operating point, and dynamically steer the multimedia sensor measurement process according to the required application needs and current physical and/or environmental constraints. Ultimately, 3D-ORAN supports settings where multimedia sensors, application constraints and operating wireless conditions may dynamically change over space, time and frequency.

As shown in FIG. 1, the 3D-O-RAN system 100 logically consists of three control engines, namely, the Network Controller (NC) 102, the Multimedia Controller (MC) 104 and the Certifiable AI Controller (CC) 106. Specifically, the NC 102 and MC 104 will (i) acquire real-time information from spectrum sensors 108 and multimedia sensors 110 for situational awareness; and (ii) influence the physical environment (i.e., spectrum utilization) and the sensing processes (i.e., spectrum sensing and multimedia sensing) with their control decisions. As such, the NC 102 and MC 104 will be highly data driven in nature, and will leverage state-of-the-art AI techniques to perform their functions. Since AI will be deeply embedded into the 3D-O-RAN system 100, it becomes fundamental to ensure that its AI algorithms will certifiably achieve Key Performance Indicators (KPIs) such as latency, accuracy, and robustness. To this end, it would be highly unrealistic to assume that the AI will always deliver the same KPIs as when first deployed, especially when operating in congested, contested, concealed and contaminated (4C) environments. For this reason, the CC 106 will dynamically modify the AI contained in the NC 102 and MC 104 according to the current applications and systems constraints, thus effectively implementing polymorphic, adaptable, and certifiable AI algorithms.

### Dynamic Certifiable AI in 3D-O-RAN

Mission-critical requirements on end-to-end deep neural network (DNN) latency and accuracy of operations are expected to continuously change in real-world tactical scenarios. 3D-O-RAN is well poised to be responsive to data availability variations.

The key challenge that sets the 3D-O-RAN system 100 apart from traditional systems is that mission-critical requirements are to be satisfied in highly-dynamic, highly-contested and resource-constrained environments. In such environments, system input data (both images/frames and spectrum waveforms), as well as the wireless channel, will be subject to noise/interference, both intentional and unintentional. Further, the available computational resources, both in terms of hardware and software, are extremely limited and may change dynamically. This implies that dynamic neural networks architectures need to be certified to meet AI-specific constraints (e.g., accuracy), device-specific constraints (e.g., energy/resource consumption) and mission-critical constraints (e.g., end-to-end latency).

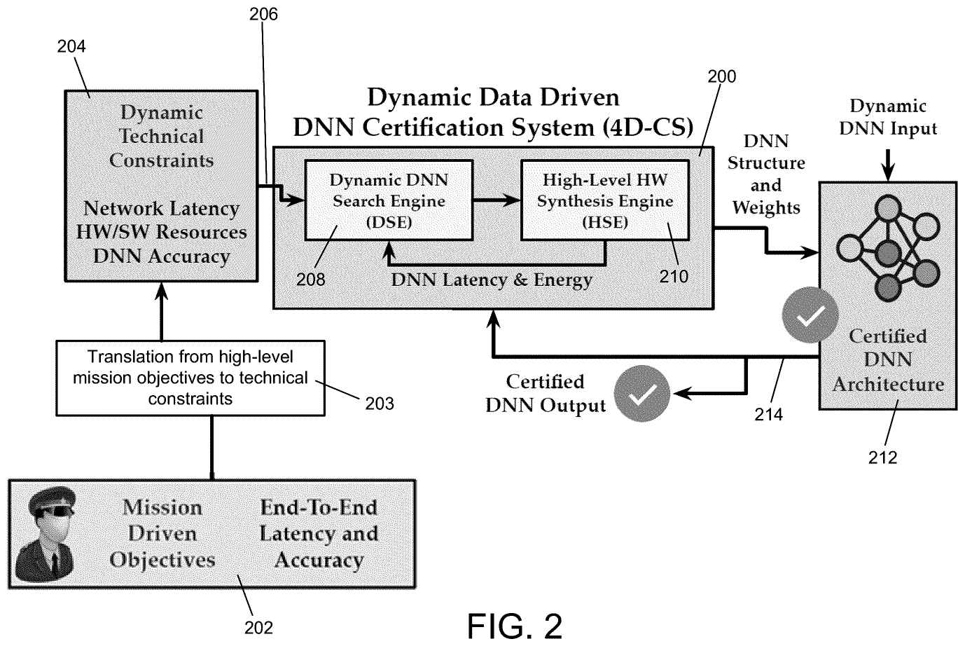

FIG. 2 shows the block diagram of an example embodiment of a Dynamic Data Driven DNN Certification System (4D-CS) 200. A key innovation of 4D-CS 200 is that application-level objectives 202, such as end-to-end latency and accuracy, are translated 203 into dynamic technical constraints 204 on network latency, hardware/software (HW/SW) resources, and DNN-level accuracy.

Ultimately, the objective of 4D-CS 200 is to establish a dynamic AI certification system, where the AI adapts itself to heterogeneous objectives. Specifically, 4D-CS 200 operates within a data-driven control loop, where technical constraints 206 are continuously fed to a dynamic DNN search engine (DSE) 208, the objective of which is to refine the DNN architecture throughout the system lifetime. A core challenge is that, in the 3D-O-RAN system 100, the inference process is distributed and the DNN input data is subject to noise/interference, which further complicates the DNN certification process.

In stark contrast with prior art systems, the DSE 208 is tasked to dynamically search for and find the right DNN architecture given (i) current 3D-O-RAN computation/network slicing allocation; (ii) current HW/SW resources on the HW platform; and (iii) current noise/interference levels in the DNN input. For this reason, the DSE 208 leverages a high-level HW synthesis engine (HSE) 210 to translate a software-defined neural network into a hardware-based architecture, for example a field-programmable gate array (FPGA)-compliant circuit configuration. The HSE 210 evaluates the selected DNN architecture, determines the DNN latency and energy consumption of the selected DNN, and provides the DNN latency and energy consumption as feedback to the DSE 208.

The certified, optimal DNN structure 212 generated by the 4D-CS 200 is a best fit for the selected system constraints at the time that the DNN structure 212 was generated. The DNN structure 212 is then instantiated as a hardware-based DNN for real-time operation in the field. 4D-CS 200 receives the certified DNN output 214 to determine whether the DNN is still maintaining acceptable performance.

Updates of the DNN structure 212 may occur when mission objectives and/or requirements change. These updates may occur as often as every few milliseconds, up to every second or tens of seconds.

While example embodiments have been particularly shown and described, it will be understood by those skilled in the art that various changes in form and details may be made therein without departing from the scope of the embodiments encompassed by the appended claims.

What is claimed is:

1. A method of generating a deep neural network (DNN), comprising:
receiving one or more application-level requirements associated with network communications;
translating the one or more application-level requirements into one or more technical constraints; and
providing the one or more technical constraints to a control loop that generates a certified DNN architecture based on the provided technical constraints.

2. The method of claim 1, wherein the mission-critical requirements comprise end-to-end network latency and DNN accuracy.

3. The method of claim 1, wherein the control loop comprises a DNN search engine and a hardware synthesis engine.

4. The method of claim 3, further comprising (i) selecting, using the DNN search engine, a candidate DNN architecture based on the technical constraints, and (ii) generating, using the hardware synthesis engine, a hardware architecture corresponding to the selected candidate DNN architecture.

5. The method of claim 4, wherein the hardware architecture comprises a DNN structure and associated weighting coefficients.

6. The method of claim 4, further comprising determining, using the hardware synthesis engine, latency and energy consumption associated with the generated DNN hardware architecture, and providing the generated latency and energy consumption associated the DNN hardware architecture to the DNN search engine.

7. The method of claim 6, further comprising revising, by the DNN search engine using the latency and energy consumption associated with the DNN hardware architecture, the selected DNN architecture to produce the certified DNN architecture.

8. The method of claim 1, wherein the technical constraints comprise one or more of (i) network latency, (ii) available hardware resources, (iii) available software resources, (iv) required DNN accuracy, (iv) computation and/or network slicing allocation, (v) current noise and/or interference levels at an input of the DNN.

9. The method of claim 1, further comprising producing, by the certified DNN architecture, a certified DNN output based on the certified DNN architecture and a dynamic DNN input, wherein the control loop revises the certified DNN architecture based on the certified output.

10. A system for generating a deep neural network (DNN), comprising:
a translation module that receives one or more application-level requirements associated with network communications, and translates the one or more application-level requirements into one or more technical constraints; and
a control loop module that uses the one or more technical constraints to generate a DNN architecture based on the provided technical constraints.

11. A method of generating a certified deep neural network (DNN) architecture, comprising:
providing one or more technical constraints to a control loop that comprises a DNN search engine and a hardware synthesis engine; and
generating, using the control loop, a certified DNN architecture based on the provided technical constraints.

12. The method of claim 11, further comprising (i) selecting, using the DNN search engine, a candidate DNN architecture based on the technical constraints, and (ii) generating, using the hardware synthesis engine, a hardware architecture corresponding to the selected candidate DNN architecture, the hardware architecture comprises a DNN structure and associated weighting coefficients.

13. The method of claim 12, further comprising determining, using the hardware synthesis engine, latency and energy consumption associated with the generated DNN hardware architecture, and providing the generated latency and energy consumption associated the DNN hardware architecture to the DNN search engine.

14. The method of claim 12, further comprising determining, using the hardware synthesis engine, latency and energy consumption associated with the generated DNN hardware architecture, and providing the generated latency and energy consumption associated the DNN hardware architecture to the DNN search engine.

15. The method of claim 14, further comprising revising, by the DNN search engine using the latency and energy consumption associated with the DNN hardware architecture, the selected DNN architecture to produce the certified DNN architecture.

16. The method of claim 11, wherein the technical constraints comprise one or more of (i) network latency, (ii) available hardware resources, (iii) available software resources, (iv) required DNN accuracy, (iv) computation and/or network slicing allocation, (v) current noise and/or interference levels at an input of the DNN.

17. The method of claim 11, further comprising producing, by the certified DNN architecture, a certified DNN output based on the certified DNN architecture and a dynamic DNN input, wherein the control loop revises the certified DNN architecture based on the certified output.

18. The method of claim 11, further comprising receiving one or more application-level requirements associated with network communications, and translating the one or more application-level requirements into the one or more technical constraints.

19. A system for generating a certified deep neural network (DNN) architecture, comprising:
a control loop module that uses the one or more technical constraints to generate a DNN architecture based on the provided technical constraints; and
the control loop module comprising a DNN search engine and a hardware synthesis engine.

20. The system of claim 19, further comprising a translation module that receives one or more application-level requirements associated with network communications, and translates the one or more application-level requirements into the one or more technical constraints.
